(19) United States
(12) Patent Application Publication
(10) Pub. No.: US 2008/0301352 A1
(43) Pub. Date: Dec. 4, 2008

(54) BUS ARCHITECTURE

(75) Inventors: P. Maurice Bland, Raleigh, NC (US); Moises Cases, Austin, TX (US); Jonathan R. Hinkle, Raleigh, NC (US); Pravin Patel, Cary, NC (US); Nam H. Pham, Round Rock, TX (US)

Correspondence Address: IBM RP-RPS;SAWYER LAW GROUP LLP, 2465 E. Bayshore Road, Suite No. 406, PALO ALTO, CA, 94303, US

(73) Assignee: International Business Machines Corporation, Armonk, NY (US)

(21) Appl. No.: 11/757,942

(22) Filed: Jun. 4, 2007

(51) Int. Cl. G06F 13/40

(52) U.S. Cl. 710/316

(57) ABSTRACT

A system and method for implementing a bus. In one embodiment, the system includes a bus switch operative to couple to a bus, and a plurality of trace segments coupled to the bus switch, where the trace segments have different lengths. The bus switch is operative to connect one of the trace segments to the bus based on at least one system requirement, and the selected trace segment cancels signal reflections on the bus.

### FIELD OF THE INVENTION

The present invention relates to computer systems, and more particularly to bus architecture.

### BACKGROUND OF THE INVENTION

High-speed bus interconnects are designed to provide the proper bandwidth connections between various logic and memory integrated circuits (ICs) in computer systems. One of the most common challenges in designing these buses is the integrity of the digital signals that are transmitted between chips. Higher frequencies on the bus are sometimes limited by the achievable signal quality at those switching rates, and thus may be limited in performance. For example, when the loading on the bus is high (e.g., more devices on the bus), the bus cannot run them very fast while maintaining adequate signal quality.

Another limitation with high-speed buses is that they experience signal reflections, also referred to as ringback, along the transmission line. Signal reflections are typically caused by electrical impedance discontinuities on a bus that cause signals to reflect in part or completely. The problem with signal reflections is that they may cause false switching, which produces bus transmission errors. This problem may be addressed by fine tuning the propagation delay of a signal. The propagation delay is the delay that a signal experiences as it travels down a transmission line, and thus determines a signal's travel time down a given interconnect. This propagation delay can be closely tuned by varying the length of the transmission line, which may cancel signal reflections. However, this method is highly frequency dependent and therefore limited in application due to variations in operating frequency, electrical topology, and loading. Because printed circuit boards take a significant amount of time to design and manufacture, a conventional solution is to design the length of transmission lines to support different bus topologies. However, this may restrict bus performance to the lowest common denominator frequencies, which compromises the performance of high-speed buses.

Accordingly, what is needed is improved bus architecture. The present invention addresses such a need.

### SUMMARY OF THE INVENTION

A system and method for implementing a bus is disclosed. In one embodiment, the system includes a bus switch operative to couple to a bus, and a plurality of trace segments coupled to the bus switch, where the trace segments have different lengths. The bus switch is operative to connect one of the trace segments to the bus based on at least one system requirement, and the selected trace segment cancels signal reflections on the bus.

According to the system and method disclosed herein, the system enables a high-speed bus to function at optimal speeds based on a variety of loading requirements.

### BRIEF DESCRIPTION OF THE DRAWINGS

FIG. 1 is a block diagram of a bus system in accordance with one embodiment.

FIG. 2 is a flow chart showing a method for implementing a bus in accordance with one embodiment of the present invention.

### DETAILED DESCRIPTION OF THE INVENTION

The present invention relates to computer systems, and more particularly to bus architecture. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiments shown, but is to be accorded the widest scope consistent with the principles and features described herein.

A system and method in accordance with the present invention for implementing a bus is disclosed. The system includes a bus switch that couples to a high-speed bus. The bus switch is coupled to multiple trace segments, each having a different length corresponding to a different system requirement such as an operating frequency. One of the trace segments is selected based on the system requirement. The bus switch is operative to connect the selected trace segment to the bus so that the selected trace segment cancels signal reflections on the bus. As a result, the system enables a high-speed bus to function at optimal speeds based on a variety of loading requirements. To more particularly describe the features of the present invention, refer now to the following description in conjunction with the accompanying figures.

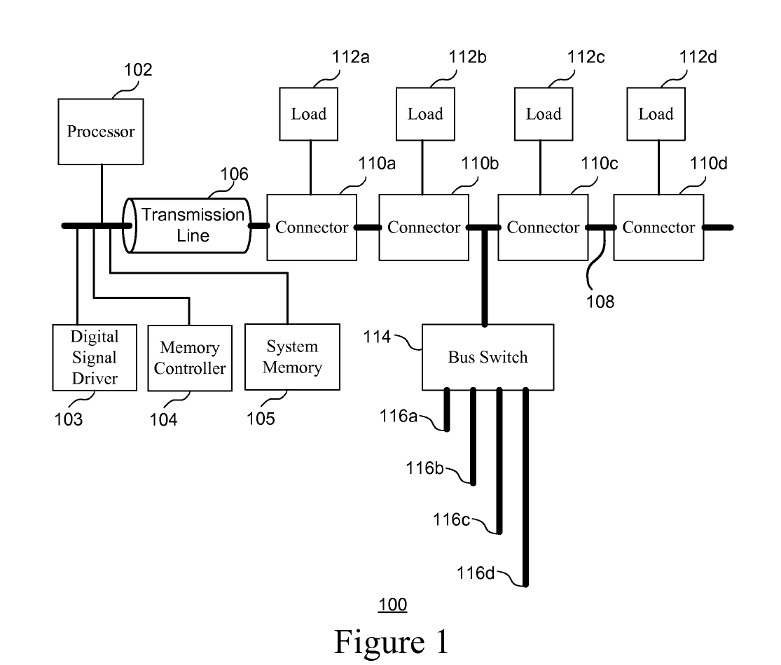

FIG. 1 is a block diagram of a bus system 100 in accordance with one embodiment. As FIG. 1 shows, the bus system 100 includes a memory controller 102 that includes a digital signal driver 104. The bus system 100 also includes a transmission line 106, and a bus 108. In one embodiment, the bus 108 is a high-speed bus. The bus 108 includes multiple connectors 110a, 110b, 110c, and 110d, which are operable to couple to respective loads 112a, 112b, 112c, and 112d. The bus system 100 also includes a bus switch 114, which is coupled to multiple trace segments 116a, 116b, 116c, and 116d. In one embodiment, the trace segments 116 are copper trace segments. For ease of illustration, four connectors 110, four loads 112, and four trace segments 116 are shown. There may be fewer or more connectors, loads, and trace segments, depending on the specific implementation and system requirements.

In operation, in one embodiment, the digital signal driver 104 resides on a chip and drives the bus 108 via the transmission line 106. In one embodiment, the four connectors 110 allow for various lengths and loads 112 to be added to the bus 108. The bus switch 114 may switch in order to add any one of the trace segments 116 to the bus 108 in order to satisfy specific requirements on the bus, such as operating frequency requirements, loading requirements, etc. In one embodiment, the bus switch 114 may be controlled by an external device, such as the memory controller 102, or other suitable device.

The generation of signal reflections is based on several factors such as the operating frequency of the bus 108, the number of connectors 110 on the bus 108, the different lengths of interconnection between the connectors 110 and their respective loads 112, and the loading due to the loads 112. Accordingly, the specific trace segment 116 selected may depend on these factors. For example, bus 108 may be more susceptible to signal reflections at higher speeds. As such, longer trace segments 116 are available to cancel the signal reflections due to the higher speeds. Accordingly, in one embodiment, the length of a given trace segment 116 may be directly related to the desired frequency of operation. If the loading is heavy (e.g., many devices are connected to the bus 108), a longer trace segment 116 may be selected.

For distributed nets, the critical design parameters are the load spacing, the load capacitances, the number of loads, and the signal transition time. Signal transition time is inversely related to operating frequency. At each impedance discontinuity (e.g., dual in-line memory module (DIMM) slots for memory sub-systems), the noise amplitude may be determined by the fastest signal transition time and the maximum load capacitance. (Net discontinuities may be represented as load capacitance for simplicity depending on the frequency spectrum of interest.) To a first order approximation, the reflective noise amplitude is proportional to capacitive load, trace characteristic impedance and signal swing and inversely proportional to signal transition time. The width of the reflective noise is approximately equal to the signal transition time. In addition, the loss energy caused by the signal reflection creates an additional delay and signal transition distortion at each discontinuity. Accordingly, as the signal frequency goes higher, there is more reflective noise and signal distortion. Each discontinuity on the net creates a similar reflective noise. If the trace segment delay is about half the signal transition time, reflective noise from adjacent discontinuities will add. In addition, reflective noise from discontinuities further down in the net could add up at critical net point (i.e., DIMM locations or controller pins) depending on trace length and operating frequency. This phenomenon is often referred to as inter-symbol interference (ISI).

The trace segments 116 have different predetermined lengths, where each length may correspond to a different system requirement such as a different frequency. For example, the trace segment 116a may correspond to 400 MHz, the trace segment 116b may correspond to 533 MHz, the trace segment 116c may correspond to 667 MHz, the trace segment 116d may correspond to 1066 MHz, etc. The specific number of trace segments available and the specific corresponding frequencies will depend on the specific implementation and specific system requirements. Accordingly, by selecting a different trace segment 116, the lengths of the traces of the bus on a given printed circuit board may be dynamically changed in order to cancel signal reflections and to reduce switching noise on the bus 108. As such, the signal quality is tuned dynamically based on a desired operating frequency.

The position of bus switch 114 (and thus the selected trace segment 116) will depend on the specific implementation and the number of loads and placement of the loads. For example, as FIG. 1 shows, bus switch 114 is coupled between the connectors 110b and 110c. In other embodiments, bus switch 114 may be coupled between another two connectors 110 (e.g., between the connectors 110a and 110b or between the connectors 110c and 110d). In other embodiments, the bus switch 114 may be coupled to the end of the bus 108, such as to the right of 110d or between the transmission line 106 and the connector 110a.

Embodiments described herein are not limited to any particular protocol interface standard. For example, embodiments may be applied to peripheral component interconnect (PCI) standards, to any memory interface standards such as double-data-rate synchronous dynamic random access memory (DDR SDRAM), DDR1, DDR2, etc., or to any other multiple drop interface.

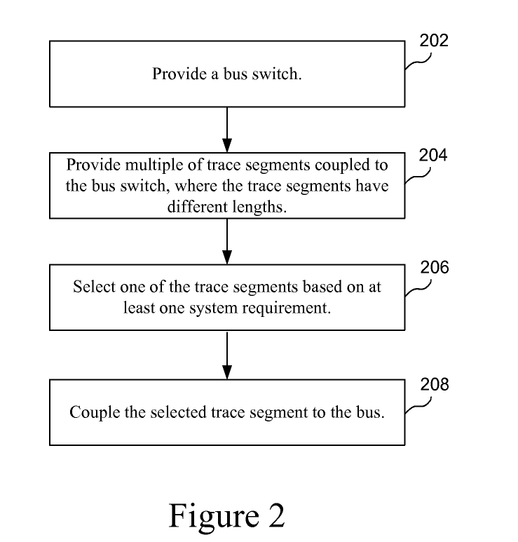

FIG. 2 is a flow chart showing a method for implementing a bus in accordance with one embodiment of the present invention. Referring to both FIGS. 1 and 2 together, the process begins in step 202 where the bus switch 114 is provided. Next, in step 204, multiple trace segments 116 are coupled to the bus switch, where the trace segments have different lengths. Next, in step 206, one of the trace segments is selected based on at least one system requirement. As described above, the system requirement may be an operating frequency, for example. Next, in step 208, the bus switch is utilized to couple the selected trace segment to the bus so that the selected trace segment cancels signal reflections on the bus.

According to the system and method disclosed herein, the present invention provides numerous benefits. For example, embodiments of the present invention enable a high-speed bus to function at optimal speeds based on a variety of loading requirements. Embodiments of the present invention also avoid having to modify copper traces of printed circuit boards, which may take a great deal of time and money. Embodiments of the present invention also support many different bus topologies without restricting the performance of the different buses. For example, a given bus may operate at the highest frequency possible.

A system and method for implementing a bus has been disclosed. The system includes a bus switch that couples to a high-speed bus and to multiple trace segments, each having a different length. One of the trace segments is selected based on a system requirement, and the bus switch connects the selected trace segment to the bus so that the selected trace segment cancels signal reflections on the bus. As a result, system enables a high-speed bus to function at optimal speeds based on a variety of loading requirements.

The present invention has been described in accordance with the embodiments shown. One of ordinary skill in the art will readily recognize that there could be variations to the embodiments, and that any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

What is claimed is:

1. A bus system comprising:
a bus switch operative to couple to a bus; and
a plurality of trace segments coupled to the bus switch, wherein the trace segments have different lengths, wherein the bus switch is operative to connect one of the trace segments to the bus based on at least one system requirement, and wherein the selected trace segment cancels signal reflections on the bus.

2. The circuit of claim 1 wherein the lengths of the trace segments are predetermined.

3. The circuit of claim 1 wherein the lengths of the trace segments correspond to different operating frequencies.

4. The circuit of claim 1 wherein the lengths of the trace segments correspond to different loads on the bus.

5. The circuit of claim 1 wherein each trace segment is a copper trace segment.

6. A system comprising:
a bus;
a bus switch operative to couple to the bus;
a device operative to control the bus switch; and
a plurality of trace segments coupled to the bus switch, wherein the trace segments have different lengths, wherein the bus switch is operative to connect one of the trace segments to the bus based on at least one system requirement, and wherein the selected trace segment cancels signal reflections on the bus.

7. The system of claim 6 wherein the lengths of the trace segments are predetermined.

8. The system of claim 6 wherein the lengths of the trace segments correspond to different operating frequencies.

9. The system of claim 6 wherein the lengths of the trace segments correspond to different loads on the bus.

10. The system of claim 6 wherein each trace segment is a copper trace segment.

11. A method for implementing a bus, the method comprising:
providing a bus switch;
providing a plurality of trace segments coupled to the bus switch, wherein the trace segments have different lengths;
selecting one of the trace segments based on at least one system requirement; and
utilizing the bus switch to couple the selected trace segment to the bus, wherein the selected trace segment cancels signal reflections on the bus.

12. The method of claim 11 wherein the lengths of the trace segments are predetermined.

13. The method of claim 11 wherein the lengths of the trace segments correspond to different operating frequencies.

14. The method of claim 11 wherein the lengths of the trace segments correspond to different loads on the bus.

15. The method of claim 11 wherein each trace segment is a copper trace segment.
